(19) United States
(12) Patent Application Publication
(10) Pub. No.: US 2014/0028717 A1
(43) Pub. Date: Jan. 30, 2014

(54) RADIATION IMAGE DISPLAYING APPARATUS AND RADIATION IMAGE DISPLAYING METHOD

(71) Applicant: FUJIFILM Corporation, Tokyo (JP)

(72) Inventor: Takashi TAJIMA, Ashigarakami-gun (JP)

(73) Assignee: FUJIFILM Corporation, Tokyo (JP)

(21) Appl. No.: 14/038,411

(22) Filed: Sep. 26, 2013

Related U.S. Application Data
(63) Continuation of application No. PCT/JP2012/001887, filed on Mar. 19, 2012.

(30) Foreign Application Priority Data
Mar. 29, 2011 (JP) 2011-071381

(51) Int. Cl. G06T 19/00

(52) U.S. Cl. CPC G06T 19/006
USPC 345/633

(57) ABSTRACT

An abnormal shadow detection section detects an abnormal shadow from each of two radiation images for displaying a stereoscopic image, obtained by imaging a subject from two different directions. A display control section determines all available combinations of abnormal shadows as abnormal shadows corresponding to each other between two radiation images in the case that a plurality of abnormal shadows are detected and for sequentially applying cursors to abnormal shadows of the determined combinations in two radiation images to sequentially display stereoscopic images marked with the cursors, in which the abnormal shadows are marked with the cursors, on the display section based on two radiation images marked with the cursors.

### BACKGROUND OF THE INVENTION

1. Field of the Invention

The present invention relates generally to a radiation image displaying apparatus and a radiation image displaying method for displaying stereoscopic images of subjects.

2. Description of the Related Art

Pieces of tissues are sometimes obtained from around lesions in clinical examinations. Recently, as a method for obtaining pieces of tissues without placing heavy burden on patients, biopsy, in which a hollow tissue collection needle (hereinafter, referred to as the “biopsy needle”) is inserted into a patient and a tissue filled in the hollow space of the needle is collected, has received wide attention. Further, a stereo biopsy apparatus has been proposed as an apparatus for implementing such biopsy.

The stereo biopsy apparatus is an apparatus that emits radiation onto a subject from different directions to obtain a plurality of radiation images having parallax among them and displays a stereoscopic image based on these radiation images. The apparatus enables the user to specify a three-dimensional position of a lesion while observing the stereoscopic image and to obtain a piece of tissue from a desired position by controlling the tip of the biopsy needle so as to move to the desired position.

Meanwhile, in the medical field, computer-aided image diagnosis (CAD: Computer Aided Diagnosis) that automatically detects abnormal shadows in images and highlights the detected abnormal shadows is known. A doctor interprets the image containing the abnormal shadow candidate detected by the CAD system, and ultimately determines whether the abnormal shadow candidate in the image represents a lesion, such as a tumor mass or calcification.

Examples of known techniques for detecting the abnormal shadow candidate include: a technique that involves applying image processing using an iris filter to a radiological image of the breast or chest and administering a threshold value process on the output value to automatically detect a candidate of a shadow of a tumor mass (a form of abnormal shadow), which is a form of cancer; and a technique that involves applying image processing using a morphology filter and administering a threshold value process on the output value to automatically detect a candidate of a shadow of a small calcification (a form of abnormal shadow), which is a form of breast cancer, etc.

Meanwhile, a radiation image is a transparent image of the interior of a subject, in which bones, various kinds of tissues and structures of a lesion such as a tumor or calcifications within the subject are contained, are overlapped with one another. Therefore, when a stereoscopic image of a radiation image is displayed, instructions such as an instruction for designating abnormal shadows are provided on the stereoscopic image by using a three-dimensional cursor which can move both in a planar direction and in a depth direction.

A technique that automatically applies a mark such as an arrow to an abnormal shadow so as to facilitate viewing of a detected abnormal shadow has been proposed (see Japanese Unexamined Patent Publication No. 2007-215717). Further, a technique that applies a mark such as an arrow to an abnormal shadow detected by CAD in a plurality of radiation images for displaying stereoscopic images, specifies an abnormal shadow in one radiation image, which corresponds to an abnormal shadow designated in the other radiation image, and further issues a warning in the case that no abnormal shadow is detected in the other radiation image, has been proposed (see Japanese Unexamined Patent Publication No. 2010-137004). A technique that detects abnormal shadows from a plurality of radiation images for three-dimensional display, and imparts parallax to the plurality of radiation images when applying marks to the detected abnormal shadows which are associated with one another so as to enable the marks to be stereoscopically viewed has also been proposed (see Japanese Unexamined Patent Publication No. 2004-337200).

In particular, the technique disclosed in Japanese Unexamined Patent Publication No. 2004-337200 removes abnormal shadows which do not geometrically correspond to each other considering parallax between the radiation images when associating the detected abnormal shadows with one another in the radiation images. Then, the technique further calculates the minimum value of the distance between the detected abnormal shadows, and associates the most equivalent abnormal shadows with each other based on the minimum value.

In the case that lesions B21, B22 exist within a subject, as shown in FIG. 17, the lesions B21, B22 are contained in a radiation image GL for a left eye and a radiation image GR for a right eye, which have been individually obtained by imaging from two positions of radiation sources PL and PR, as abnormal shadows BL21, BL22; and abnormal shadows BR21, BR22, respectively. However, in such a case, the technique disclosed in Japanese Unexamined Patent Publication No. 2004-337200 cannot specify which of the abnormal shadows BR21 and BR22 the abnormal shadow BL21 corresponds to, and which of the abnormal shadows BR21 and BR22 the abnormal shadow BL22 corresponds to, when the positions of the lesions B21 and B22 are the same in a direction perpendicular to the plane of the drawing sheet (a Y direction).

In such a manner, if corresponding abnormal shadows cannot be specified, the same mark cannot be applied to the corresponding abnormal shadows. In particular, the tip of a biopsy needle cannot be precisely brought to a position of an abnormal shadow in stereo biopsy.

For this reason, radiation images are obtained by additionally imaging from one or more imaging directions that is different from the imaging directions, in which two radiation images are obtained, and abnormal shadows can be precisely associated with each other in the two radiation images by using the obtained additional radiation images. However, performing imaging merely for the purpose of associating abnormal shadows with each other increases the amount of radiation to which a subject is exposed. Further, the number of operations by an operator will be increased, more time for test and examination will be required, and the burden on a patient as a subject will be increased. Therefore, a technique that employs an image of an abnormal shadow detected in one of two radiation images to detect an abnormal shadow within the other radiation image, so that abnormal shadows can be precisely associated with each other without increasing the amount of radiation to which a subject is exposed has been proposed (see U.S. Patent Application Publication No. 20100208958).

Further, a technique that two-dimensionally displays one of two radiation images, specifies an abnormal shadow on the two-dimensionally displayed image, searches for the specified abnormal shadow in the other radiation image, and displays a stereoscopic image in which the corresponding abnormal shadow is marked by using the search result has also been proposed (see Japanese Unexamined Patent Publication No. 2009-213519).

### SUMMARY OF THE INVENTION

In the case that a plurality of abnormal shadows are detected within radiation images for displaying a stereoscopic image, the techniques disclosed in Japanese Unexamined Patent Publication No. 2010-137004 and Japanese Unexamined Patent Publication No. 2004-337200 can be employed to display stereoscopic images with marks in which the plurality of abnormal shadows are marked. Further, in the case that a three-dimensional cursor is utilized to designate an abnormal shadow, a three-dimensional cursor can be substituted for a mark to display the abnormal shadows marked with the three-dimensional cursors by the techniques disclosed in Japanese Unexamined Patent Publication No. 2010-137004 and Japanese Unexamined Patent Publication No. 2004-337200.

Further, in the case that a three-dimensional cursor is displayed, the techniques disclosed in U.S. Patent Application Publication No. 20100208958 and Japanese Unexamined Patent Publication No. 2009-213519 can be employed to specify abnormal shadows which correspond to each other in two radiation images. However, the techniques disclosed in U.S. Patent Application Publication No. 20100208958 and Japanese Unexamined Patent Publication No. 2009-213519 require substantial time to carry out the process in which an image of an abnormal shadow detected in one radiation image is used to detect an abnormal shadow within the other radiation image.

In view of the above-described circumstances, the objective of the present invention is to enable efficient correspondence between abnormal shadows in a short time in two radiation images.

A radiation image displaying apparatus according to the present invention includes:

an abnormal shadow detection section for detecting an abnormal shadow from each of two radiation images for displaying a stereoscopic image, obtained by imaging a subject from two different directions;

a display section for displaying the stereoscopic image; and

a display control section for determining all available combinations of abnormal shadows as abnormal shadows corresponding to each other between two radiation images in the case that a plurality of abnormal shadows are detected and for sequentially applying cursors to abnormal shadows of the determined combinations in two radiation images to sequentially display stereoscopic images marked with the cursors, in which the abnormal shadows are marked with the cursors, on the display section based on two radiation images marked with the cursors.

It should be noted that the radiation image displaying apparatus may further include an input section for receiving input of instructions for determining combinations of abnormal shadows to be marked with cursors, wherein:

the display control section may be for specifying the abnormal shadows of the determined combinations as corresponding abnormal shadows.

Further, in the radiation image displaying apparatus according to the present invention, the display control section may be for excluding combinations which cannot geometrically exist from the combinations of abnormal shadows, then sequentially displaying the stereoscopic images marked with cursors.

Further, in the radiation image displaying apparatus according to the present invention, the display control section may sequentially apply cursors to combinations of abnormal shadows starting from a combination of abnormal shadows which are close to each other, then sequentially displaying stereoscopic images marked with cursors.

Further, in the radiation image displaying apparatus according to the present invention, the display control section may exclude combinations based on the determined combinations, then sequentially display the stereoscopic images marked with cursors, in the case that combinations of abnormal shadows are determined.

Further, in the radiation displaying apparatus according to the present invention, the display control section may judge whether a plurality of abnormal shadows are arranged in a direction corresponding to two directions of two radiation images and determine combinations of the abnormal shadows and display the stereoscopic images marked with cursors only in the case that an affirmative judgment is made.

In this case, a corresponding object included in each of two radiation images has parallax by being imaged from two directions. A direction of this parallax is a direction in which a line connected between positions of the radiation sources respectively corresponding to two directions extends, in the case that the line is projected onto the radiation images. Accordingly, the expression “a direction corresponding to two directions” refers to a direction of parallax in two radiation images.

Further, in the radiation image displaying apparatus according to the present invention, the display control section may display either one of two radiation images on the display section and sequentially apply cursors merely to combinations of abnormal shadows designated in the displayed radiation image, and sequentially display the stereoscopic images marked with the cursors.

A radiation image displaying method according to the present invention which is employed in a radiation image displaying apparatus including an abnormal shadow detection section that detects abnormal shadows from each of two radiation images for displaying a stereoscopic image, obtained by imaging a subject from two different directions and a display section that displays a stereoscopic image, the radiation image displaying method including:

determining all available combinations of abnormal shadows as abnormal shadows corresponding to each other between two radiation images in the case that a plurality of abnormal shadows are detected;

sequentially applying cursors to abnormal shadows of the determined combinations in two radiation images; and

sequentially displaying stereoscopic images marked with the cursors, in which the abnormal shadows are marked with the cursors, on the display section, based on two radiation images marked with the cursors.

According to the present invention, all available combinations of abnormal shadows are determined as abnormal shadows corresponding to each other between two radiation images in the case that a plurality of abnormal shadows are detected, abnormal shadows of the determined combinations are sequentially marked with cursors in two radiation images, and stereoscopic images in which the abnormal shadows are marked with the cursors are sequentially displayed on the display means, based on two radiation images marked with the cursors.

Thereby, an operator can confirm which combinations of abnormal shadows are appropriate, i.e., which abnormal shadows correspond to each other in two radiation images by observing the stereoscopic images marked with cursors which are sequentially displayed. This eliminates the need to carry out processes to search for abnormal shadows corresponding to each other in two radiation images. Thereby, the corresponding abnormal shadows can be efficiently specified in a short time, and the stereoscopic images in which the corresponding abnormal shadows are marked with the three-dimensional cursors can be displayed.

Abnormal shadows corresponding to the same lesion can be correlated to each other by receiving input of instructions for determining combinations of abnormal shadows to be marked with cursors and specifying the abnormal shadows of the determined combinations as corresponding abnormal shadows.

Further, if the combinations which cannot geometrically exist are excluded from the combinations of abnormal shadows, it will no longer be necessary to display the stereoscopic images marked with cursors by applying the cursors to the combinations of abnormal shadows, which cannot exist as the corresponding abnormal shadows. This enables the combinations of abnormal shadows corresponding to each other in two radiation images to be determined more quickly.

Further, cursors are applied to combinations of abnormal shadows starting from a combination of abnormal shadows, which are disposed very close to each other, in two radiation images, and thereby combinations of the corresponding abnormal shadows can be efficiently determined in an early stage when the stereo images marked with cursors are sequentially displayed.

In the case that the combinations of abnormal shadows are determined, if combinations are excluded based on the determined combinations, the number of the remaining combinations of abnormal shadows can be reduced. Thereby the combinations of corresponding abnormal shadows can be efficiently determined in a short time.

By judging whether a plurality of abnormal shadows are arranged in a direction corresponding to two directions of two radiation images to determine combinations of the abnormal shadows and display stereoscopic images marked with cursors only in the case that an affirmative judgment is made, in the case that corresponding abnormal shadows is easily specified, it will no longer be necessary to perform the processes of the present invention and thereby processes for applying cursors to the corresponding abnormal shadows can be carried out rapidly.

Further, by displaying either one of two radiation images on the display section and sequentially applying cursors only to the combinations of abnormal shadows specified in the displayed radiation image to sequentially display stereoscopic images with cursors, combinations of corresponding abnormal shadows can be efficiently and rapidly determined of desired abnormal shadows.

### BRIEF DESCRIPTION OF THE DRAWINGS

FIG. 1 is a schematic configuration diagram of a stereo breast image capturing and displaying system that utilizes an embodiment of the radiation image displaying apparatus of the present invention.

FIG. 2 illustrates an arm section of the stereo breast image capturing and displaying system shown in FIG. 1 viewed from the right side in FIG. 1.

FIG. 3 illustrates an image capturing platform of the stereo breast image capturing and displaying system shown in FIG. 1 viewed from above.

FIG. 4 is a block diagram of a computer of the stereo breast image capturing and displaying system shown in FIG. 1, illustrating the schematic configuration thereof.

FIG. 5 is a first flowchart illustrating the processes carried out in the present embodiment.

FIG. 6 is a second flowchart illustrating the processes carried out in the present embodiment.

FIG. 7 is a diagram illustrating a state in which a corresponding abnormal shadow cannot be specified.

FIG. 8 is a diagram for explaining determination of an order of a plurality of abnormal shadows.

FIG. 9 is a diagram illustrating abnormal shadows included in right and left radiation images.

FIG. 10 is a diagram for explaining determination of an order of a plurality of abnormal shadows in the case of a biopsy.

FIG. 11 is a diagram illustrating combinations and an order of display of determined combinations of abnormal shadows.

FIG. 12 is a diagram for explaining exclusion of combinations, which cannot geometrically exist, from among the determined combinations.

FIG. 13 is a diagram for explaining another example of exclusion of combinations, which cannot geometrically exist, from among the determined combinations.

FIG. 14 is a first schematic view illustrating radiation images and a stereo image accompanied with a cursor to be displayed on a monitor.

FIG. 15 is a second schematic view illustrating radiation images and a stereo image accompanied with a cursor to be displayed on a monitor.

FIG. 16 is a flowchart illustrating other processes carried out in the present embodiment.

FIG. 17 is a diagram illustrating a state in which corresponding abnormal shadows cannot be specified.

### DESCRIPTION OF THE PREFERRED EMBODIMENTS

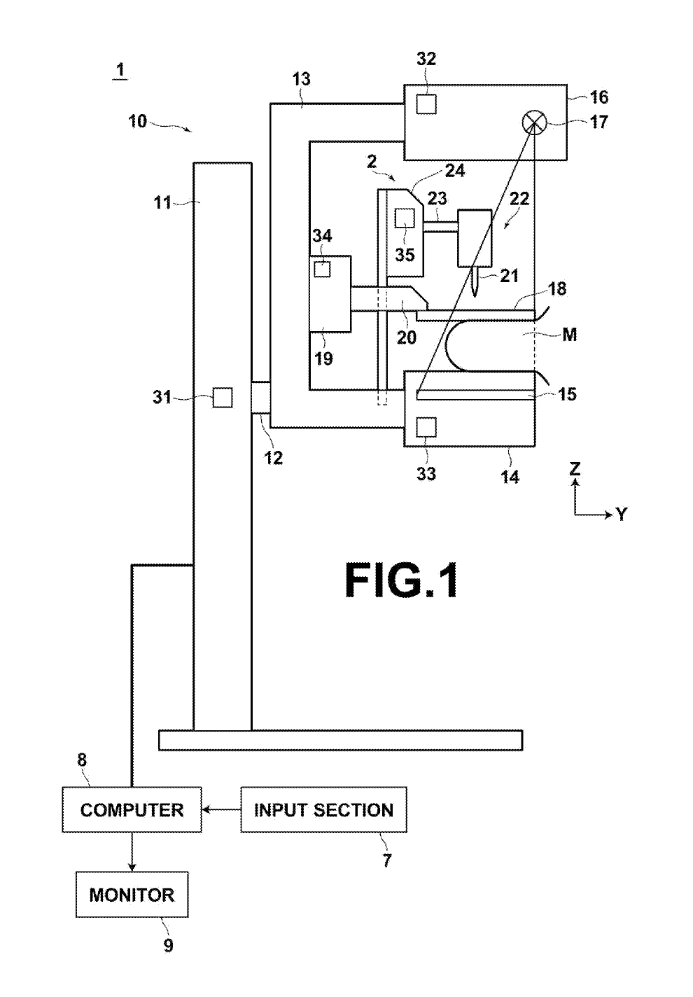

Hereinafter, a stereo breast image capturing and displaying system that utilizes an embodiment of the radiation image displaying apparatus of the present invention will be described with reference to the accompanying drawings. The breast image capturing and displaying system of the present embodiment is a system that may function as a stereo breast biopsy apparatus by attaching a removably attachable biopsy unit. First, the schematic configuration of the entire breast image capturing and displaying system of the present embodiment will be described. FIG. 1 schematically illustrates the configuration of the stereo breast image capturing and displaying system with a biopsy unit being attached thereto as the embodiment of the present invention.

As shown in FIG. 1, the breast image capturing and displaying system 1 of the present embodiment includes a breast image capturing apparatus 10, a computer 8 connected to the breast image capturing apparatus 10, and a monitor 9 (display section) and an input section 7 connected to the computer 8.

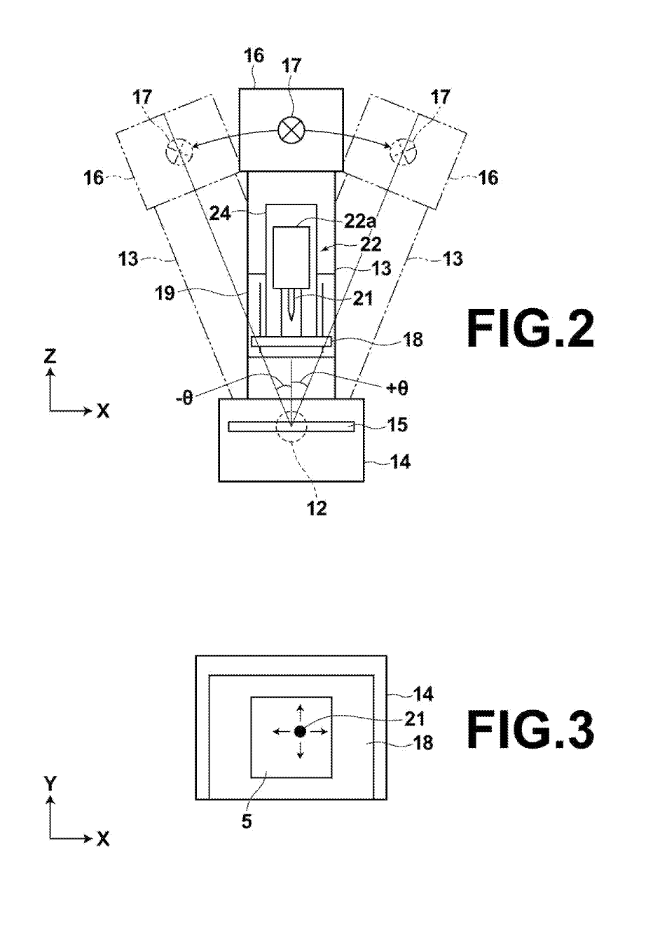

As shown in FIG. 1, the breast image capturing apparatus 10 includes a base 11, a rotary shaft 12 which is movable in up and down directions with respect to the base 11 (Z directions), as well as being rotatable, and an arm section 13 coupled to the base 11 via the rotary shaft 12. FIG. 2 shows the arm section 13 viewed from the right side in FIG. 1.

The arm section 13 is in the shape of the letter C. An image capturing platform 14 is attached to one side of the arm section 13 and a radiation emission section 16 is attached to the other side so as to face the image capturing platform 14. The rotation and vertical movement of the arm section 13 are controlled by an arm controller 31 incorporated in the base 11.

The image capturing platform 14 includes therein a radiation image detector 15, such as a flat panel detector or the like, and a detector controller 33 that controls charge signal reading from the radiation image detector 15. The image capturing platform 14 further includes a circuit board having thereon a charge amplifier that converts charge signals read out from the radiation image detector 15 to voltage signal, a correlated double sampling circuit that samples the voltage signals output from the charge amplifier, and an A/D converter that converts the voltage signals to digital signals, and the like.

The image capturing platform 14 is configured to be rotatable with respect to the arm section 13 and the orientation of the image capturing platform 14 can be fixed with respect to the base 11 even when the arm section 13 is rotated with respect to the base 11.

The radiation image detector 15 is capable of being used repeatedly for radiation image recording and reading. As the radiation image detector 15, a so-called direct type radiation image detector that generates charges by receiving radiation or a so-called indirect type radiation image detector that converts radiation to visible light first and then converts the visible light to charge signal may be used. As for the radiation image signal readout method, a so-called TFT (thin film transistor) readout method in which radiation image signals are read out by switching TFT switches ON/OFF or an optical readout method in which radiation image signals are read out by directing readout light to the detector is preferable, but other methods may also be used.

The radiation emission section 16 includes therein a radiation source 17 and a radiation source controller 32. The radiation source controller 32 controls emission timing of radiation from the radiation source 17 and radiation generation conditions (tube current, time, tube current-time product, and the like) for the radiation source 17.

Further, a compression paddle 18, disposed above the image capturing platform 14, for holding and compressing a breast M, a support section 20 for supporting the compression paddle 18, and a moving mechanism 19 for moving the support 20 in up and down directions (Z directions) are provided on a center portion of the arm section 13. The position and compression pressure of the compression paddle 18 are controlled by a compression paddle controller 34. FIG. 3 shows the compression paddle 18 of FIG. 1 viewed from above. As shown in FIG. 3, the compression paddle 18 has an opening 5 of a size of about 10×10 cm to enable biopsy to be performed with the breast M being fixed by the image capturing platform 14 and the compression paddle 18.

The biopsy unit 2 is mechanically and electrically connected to the breast image capturing and displaying system 1 when the base portion thereof is inserted into the opening of the support 20 of the compression paddle 18 and the lower end thereof is fixed to the arm section 13.

The biopsy unit 2 has a removably attachable biopsy needle unit 22 that includes a biopsy needle 21 to be punctured into the breast, a needle support section 23 for supporting the biopsy needle unit 22, and a moving mechanism 24 for moving the biopsy needle unit 22 in the X, Y, or Z direction shown in FIGS. 1 to 3 by moving the needle support 23 along a rail or by extending or retracting the needle support 23. The position of the tip of the biopsy needle 21 of the biopsy needle unit 22 is recognized as position information (x, y, z) in a three-dimensional space and controlled by a needle position controller 35 of the moving mechanism 24. Note that the direction perpendicular to the drawing sheet of FIG. 1 is the X direction, the direction perpendicular to the drawing sheet of FIG. 2 is the Y direction, and the directions perpendicular to the drawing sheet of FIG. 3 is the Z direction.

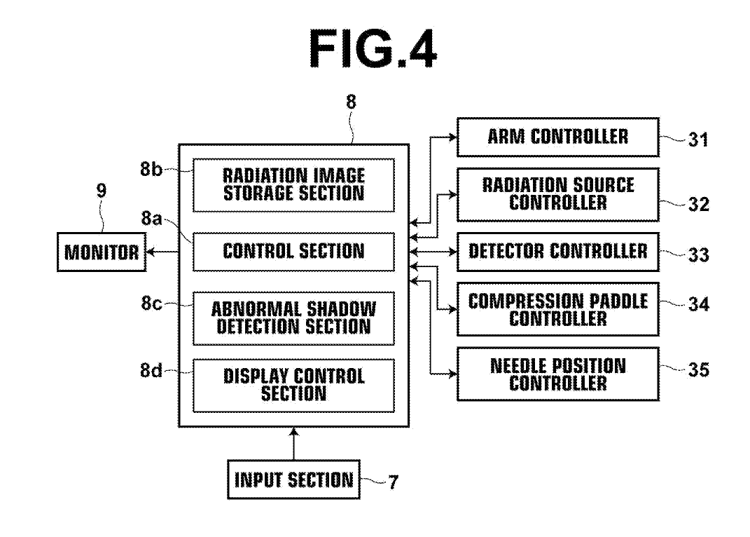

The computer 8 includes a central processing unit (CPU), a storage device, such as a semiconductor memory, hard disk, SSD, or the like, that constitute a control section 8a, a radiation image storage section 8b, an abnormal shadow detection section 8c, and a display control section 8d shown in FIG. 4.

The control section 8a outputs predetermined control signals to each of the controllers 31 to 35 to perform control of the entire system. A specific control method will be described later in detail.

The radiation image storage section 8b is a section for storing radiation image signals with respect to each imaging angle obtained by the radiation image detector 15.

The abnormal shadow detection section 8c is a section for analyzing a radiation image represented by radiation image signals for each imaging angle and automatically detecting the position of an abnormal shadow within the breast included in the radiation image. A method for detecting abnormal shadows can be performed based on the concentration distribution and morphological features of abnormal shadows. In particular, an iris filter process (e.g., see U.S. Pat. No. 5,940,527) suitable for mainly detecting a tumor shadow, a morphology filter process (e.g., see Japanese Unexamined Patent Publication No. 8 (1996)-294479) suitable for mainly detecting a micro-calcification shadow and the like may be employed to detect abnormal shadows. Further, the abnormal shadow detection section 8c determines an order of abnormal shadows when a plurality of abnormal shadows are detected. The determination of the order will be described later.

The display control section 8d is a section for displaying a stereo image using two radiation images on the monitor 9 or for displaying a three-dimensional cursor at the position of an abnormal shadow in the stereo image as described later.

The input section 7 is constituted, for example, by a keyboard and a pointing device such as a mouse, and is configured to be able to designate the positions of abnormal shadows and the like within the stereo image displayed on the monitor 9 with a cursor. The input section 7 also receives input of imaging conditions or operational instructions from the operator, or input of instructions for determining combinations of abnormal shadows to be described later.

The monitor 9 is a display means designed to display a stereo image using two radiation image signals output from the computer 8. A method for three-dimensionally displaying images on the monitor 9 may include, for example, a method in which radiation images are displayed on two different screens respectively and one of them is input to the right eye while the other is input to the left eye of an observer using a half mirror or a polarization glass. Alternatively, for example, a method may be employed in which a stereo image is displayed by superimposing the two radiation images and viewing the radiation images with a polarization glass. Further, a method may be employed in which the monitor 9 is constituted by 3D liquid crystal display to enable stereoscopically viewing two radiation images as in the parallax barrier method or lenticular method.

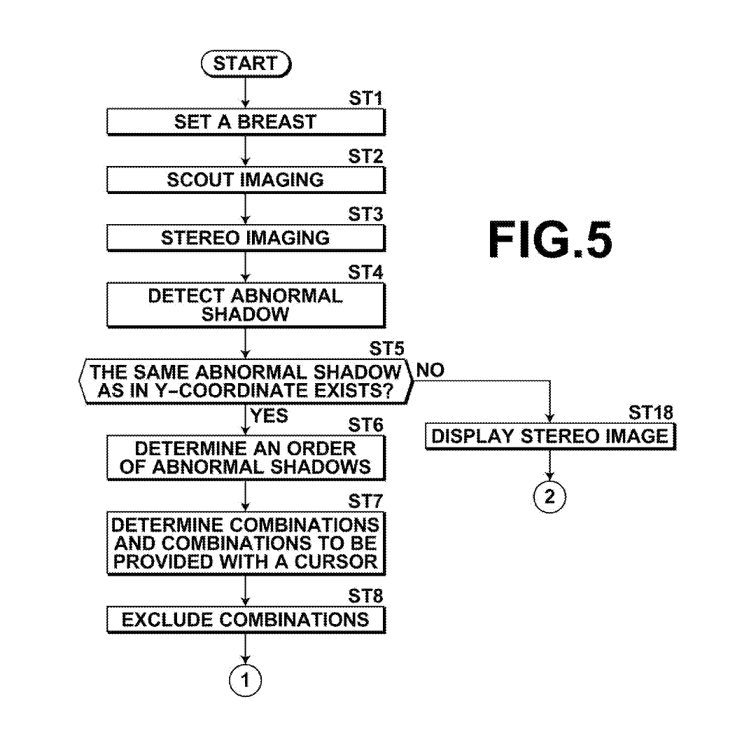

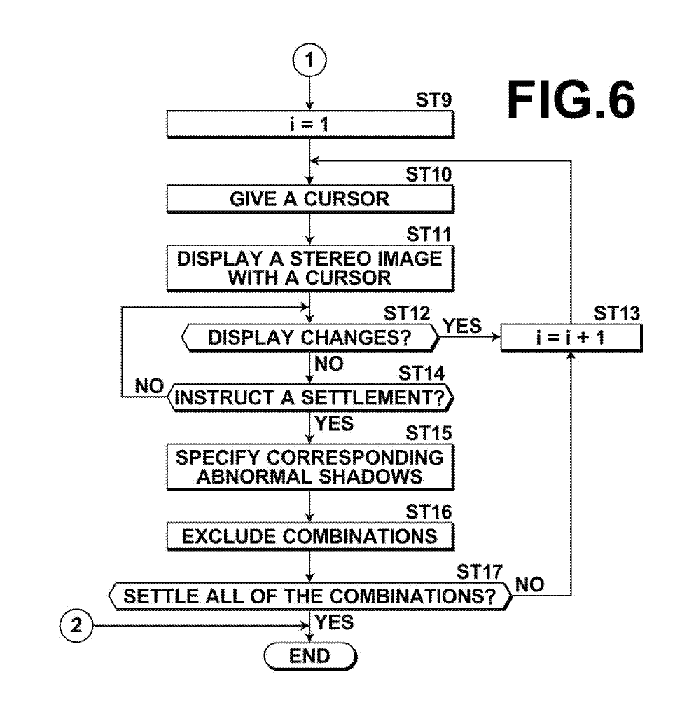

An operation of the breast image capturing and displaying system of the present embodiment will now be described with reference to the flowchart shown in FIGS. 5 and 6.

First, a breast M is placed on the image capturing platform 14 and the breast is compressed by the compression paddle 18 at a predetermined pressure (step ST11).

Next, various imaging conditions are input from the input section 7 by the operator, and then an instruction for starting an imaging operation is input. At this time, the biopsy needle unit 22 stands by above and is not punctured into the breast.

Then, if an instruction to start the imaging operation is received from the input section 7, a scout image capturing operation is performed prior to the image capturing of the stereo image of the breast M (step ST12). Specifically, the control section 8a outputs control signals to the radiation source controller 32 and the detector controller 33 to start emitting radiation and to start reading radiation image signals respectively so as to perform the biopsy scout image capturing operation. In this case, the arm section 13 is at a position perpendicular to the imaging capturing platform 14 at a default position. Thereby, in response to the control signal, radiation is emitted from the radiation source 17 and the radiation image of the breast imaged from a perpendicular direction (θ=0) is detected by the radiation detector 15. Further, the radiation image signals are read out by the detector controller 33 and the radiation image signals are subjected to predetermined signal processes so as to be stored in the radiation image storage section 8b of the computer 8 as radiation image signals of a scout image GS.

The scout image GS obtained by the scout image capturing is displayed on the monitor 9. The operator determines the position of the breast M such that an abnormal shadow viewed in the scout image is located at a position of an opening 5 of the compression paddle 18, while observing the scout image.

Next, the control section 8a reads out an angle θ which corresponds to one-half of a preset convergence angle for capturing a stereo image and outputs the information of the readout angle θ to the arm controller 31. In the present embodiment, it is assumed that, as the information of the angle θ, θ=15° (a convergence) angle=30° is stored in advance. However, the angle is not limited to the above, for example, in the case that biopsy is not performed, any angle within a range from θ=2° to θ=5°, which enables successful stereoscopic viewing, may be used.

Then, if an instruction to start the imaging operation is received from the input section 7, a stereo imaging operation of the breast M is performed (stereo imaging, step ST13). The information of the convergence angle θ output from the control section 8a is received by the arm controller 31 which in turn outputs a control signal, based on the information of the convergence angle θ, for causing the arm section 13 to rotate by +θ with respect to the direction perpendicular to the image capturing platform 14. That is, the arm controller 31 outputs a control signal for causing the arm section 13 to rotate by +15° with respect to the direction perpendicular to the image capturing platform 14 in the present embodiment.

Then, in response to the control signal output from the arm controller 31, the arm section 13 rotates by +15°. Subsequently, the control section 8a outputs control signals to the radiation source controller 32 and the detector controller 33 to start emitting radiation and to start reading radiation image signals respectively. In response to these control signals, the following procedures are performed: radiation is emitted from the radiation source 17; a radiation image of a breast captured from the +15° direction is detected by the radiation image detector 15; radiation image signals are read out by the detector controller 33; the radiation image signals are subjected to predetermined signal processes; and the radiation image signals subjected to the signal processes are stored in the radiation image storage section 8b of the computer 8. In this case, it is assumed that the radiation image signals stored in the radiation image storage section 8b by this imaging operation represents a radiation image GR for the right eye.

Then, the arm controller 31 returns the arm section to the initial position and then outputs a control signal for causing the arm section 13 to rotate by −θ with respect to the direction perpendicular to the image capturing platform 14, as illustrated in FIG. 2. That is, the arm controller 31 outputs control signal for causing the arm section 13 to rotate by −15° with respect to the direction perpendicular to the image capturing platform 14 in the present embodiment.

Then, in response to the control signal output from the arm controller 31, the arm section 13 rotates by −15°. Subsequently, the control section 8a outputs control signals to the radiation source controller 32 and the detector controller 33 to start emitting radiation and to start reading radiation image signals respectively. In response to these control signals, the following procedures are performed: radiation is emitted from the radiation source 17; a radiation image of a breast captured from the −15° direction is detected by the radiation image detector 15; radiation image signals are read out by the detector controller 33; the radiation image signals are subjected to predetermined signal processes; and the radiation image signals subjected to the signal processes are stored in the radiation image storage section 8b of the computer 8. In this case, it is assumed that the radiation image signal stored in the radiation image storage section 8b by this imaging operation represents a radiation image GL for the left eye.

Thereafter, an anesthetic is administered to the breast M and the stereo imaging is performed again. Note that in the case that set positions of the breast M differ between positioning of the breast M before and after administering an anesthetic thereto, the stereo imaging will be performed again. Meanwhile, in the case that the set positions of the breast M are substantially the same between positioning of the breast M before and after administering an anesthetic thereto, the stereo imaging will not be performed again so as to reduce radiation exposure to a subject.

Next, an abnormal shadow of a lesion of a calcification, tumor or the like in the breast is detected by the abnormal shadow detection section 8c from the radiation image GL for the left eye and the radiation image GR for the right eye (step ST4). In the present embodiment, it is assumed that a plurality of abnormal shadows are detected.

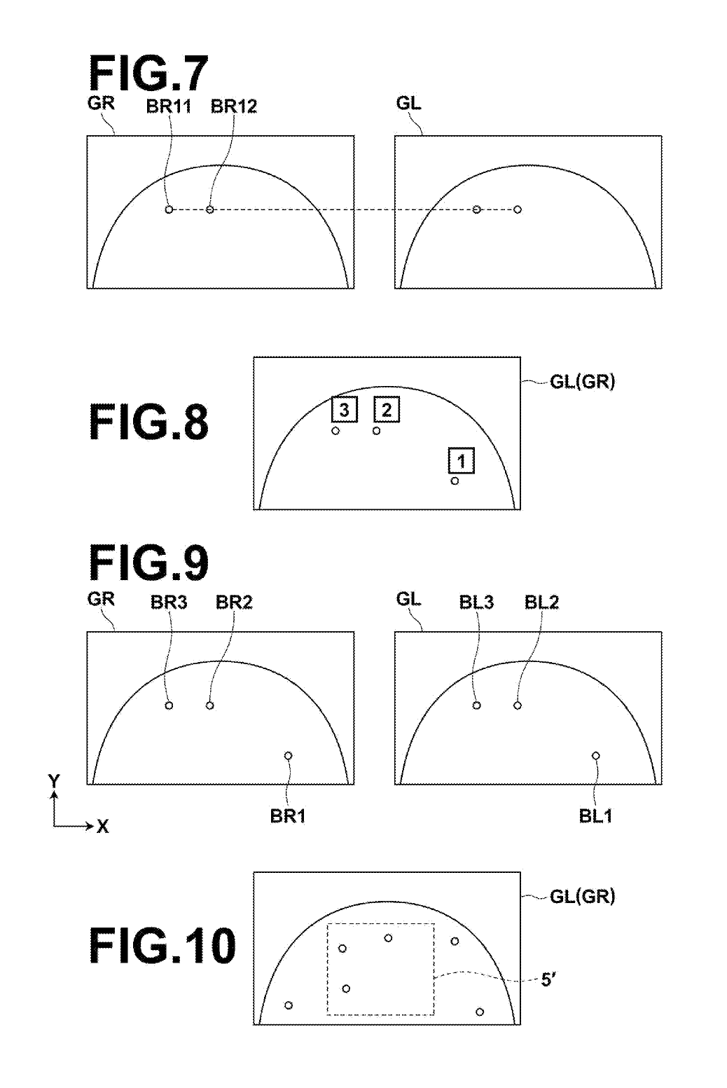

Furthermore, the abnormal shadow detection section 8c determines whether abnormal shadows having substantially the same y-coordinate values exist in the radiation images GL, GR (step ST5). In this case, as shown in FIG. 7, in the case that two abnormal shadows BR11, BR12 are contained in the radiation image GR for the right eye and have the same y-coordinate values, it is unclear which of two abnormal shadows present in the radiation image GL for the left eye the abnormal shadow BR11 corresponds to. Thereby, the abnormal shadow specification section 8c determines an order of the detected plurality of abnormal shadows first (step ST6) to perform processes for specifying abnormal shadows if an affirmative determination is made in step ST5. In particular, as shown in FIG. 8, the order of the abnormal shadows is decided starting from the right in the radiation image GL (GR) for the left eye or the right eye. Note that, it is assumed that three abnormal shadows have already been detected in FIG. 8. In this case, three abnormal shadows are detected in each of the two radiation images GL, GR. As shown in FIG. 9, the abnormal shadows in the radiation image GR for the right eye are designated by the reference numerals BR1, BR2, BR3 from right to left and the abnormal shadows in the radiation image GL for the left eye are designated by the reference numerals BL1, BL2, BL3 from right to left.

Further, as an output value of the iris filter or that of the morphology filter is higher, malignancy of an abnormal shadow becomes higher, and thereby the order may be decided in descending order of malignancy. Alternately, the order of calcification may be upgraded, or conversely, the order of tumor may be upgraded. Alternately, in the case that aggregated calcification, in which a plurality of calcification clusters are close together, exist, the order of aggregated calcification may be upgraded (for example, the order may be No. 1).

Biopsy is conducted in the present embodiment, and thereby the order may be established with respect to only an area 5′ corresponding to the opening 5 of the compression paddle 18 in the radiation image GL (GR), as shown in FIG. 10.

Meanwhile, if a negative determination is made in step ST 5, the abnormal shadows having the closest coordinate positions are correlated to each other in the radiation images GL and GR. The correlated abnormal shadows in the radiation images GL and GR are marked with cursors, and a stereo image based on the radiation images GL and GR marked with the cursors is displayed on the monitor 9 (step ST18). Thereby, the process is completed.

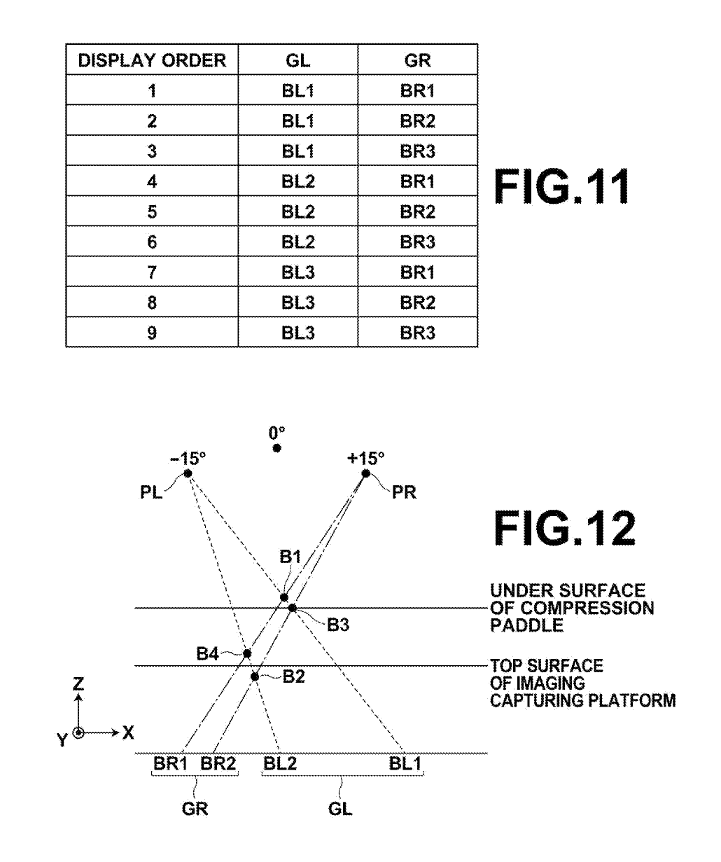

Following step ST6, the display control section 8d determines all possible combinations among the plurality of abnormal shadows which have been detected in each of the radiation images GL, GR, and decides the order of the combinations of abnormal shadows to be three-dimensionally displayed with the cursors imparted thereto (step ST7). As shown in FIG. 9, in the case that abnormal shadows BR1, BR2, BR3 are included in the radiation image GR for the right eye and abnormal shadows BL1, BL2, BL3 are included in the radiation image GL for the left eye, combinations and a display order of abnormal shadows are decided as shown in FIG. 11. That is, the display order is determined in order starting from a combination of an abnormal shadow, which is taken in order starting from the right, and an abnormal shadow which is taken in order starting from a position closest thereto in x direction, in the radiation images GL and GR, respectively.

Next, the display control section 8d excludes combinations, which cannot geometrically exist, from among the determined combinations (step ST8). FIG. 12 is a diagram for explaining exclusion of combinations, which cannot geometrically exist, from among the determined combinations. In this case, it is assumed that two abnormal shadows are included in each of the radiation images GL, GR. Further, in the following description, it is assumed that the z-coordinate of a detection surface of the radiation detector 15 is 0. Further, it is also assumed that, the abnormal shadows in the radiation image GL for the left eye are BL1, BL2; the abnormal shadows in the radiation image GR for the right eye are BR1, BR2; the position of a radiation source at +15° is PL; and the position of a radiation source at −15° is PR. The abnormal shadow specification section 8d sets intersection points B1, B4 of a path of radiation emitted from the position PL of the radiation source at −15° to the abnormal shadows BL1, BL2 and a path of radiation emitted from the position PR of the radiation source at +15° to the abnormal shadow BR1; and intersection points B2, B3 of a path of radiation emitted from the position PL of the radiation source at −15° to the abnormal shadows BL1, BL2 and a path of radiation emitted from the position PR of the radiation source at +15° to the abnormal shadow BR2, as shown in FIG. 12. Note that each of the intersection points B1 through 34 is a position where a lesion could possibly exist.

In this case, the y-coordinate of an abnormal shadow cannot be at a position above the undersurface of the compression paddle 18 or at a position below the upper surface of the image capturing platform 14. Therefore, it can be judged that a lesion cannot exist at intersection points, in which the z-coordinate of each of the computed intersection points B1 through B4 is at a position above the undersurface of the compression paddle 18 or at a position below the upper surface of the image capturing platform 14. For example, as shown in FIG. 12, in the case that the z-coordinate of the intersection point B1 is at a position above the undersurface of the compression paddle 18 or the z-coordinate of the intersection point B2 is at a position below the image capturing platform 14, it is assumed that a lesion does not exist at the intersections points B1, B2. In this case, combinations of abnormal shadows in which the positions of intersection points B1, B2 become lesions are excluded from the determined combinations.

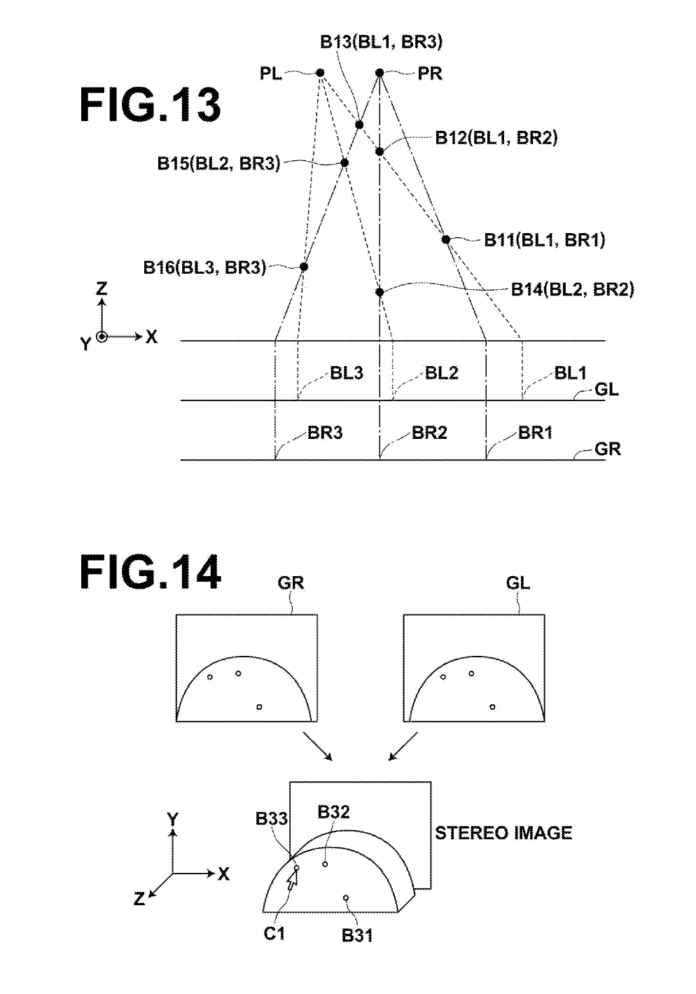

FIG. 13 is a diagram for explaining another example of exclusion of combinations, which cannot geometrically exist, from among the determined combinations. In this case, three abnormal shadows BL1, BL2, BL3 (BR1, BR2, BR3) are included in the radiation image GL (GR) obtained by imaging from the radiation source positions PL (PR). In the example of FIG. 13, there are six intersection points B11 through B16 between a path of radiation emitted from the radiation source position PL toward the abnormal shadows BL1, BL2, BL3 and a path of radiation emitted from the radiation source position PR toward the abnormal shadows BR1, BR2, BR3.

The position of the intersection point B11 in FIG. 13 is a position of a lesion determined from the abnormal shadows BL1, BR1 included in the radiation images GL, GR. However, in the case that the abnormal shadows BL1, BR1 actually correspond to different lesions, a combination of an abnormal shadow to be assumed as a next candidate is the abnormal shadow BL1, BR2, and the position of a lesion determined by the combination is the intersection point B12. In this case, the abnormal shadow BL2 corresponds only to the abnormal shadow BR3, and the position of a lesion determined by the combination is the intersection point B15. Further in this case, although the abnormal shadow BL3 corresponds only to the abnormal shadow BR1, the combination of the abnormal shadows BL3, BR1 cannot geometrically exist, as shown in FIG. 13. Accordingly, in such a case, the combinations of abnormal shadows BL1, BR2; the abnormal shadows BL2, BR3; and the abnormal shadows BL3, BR1 should be excluded from the determined combinations.

The display control section 8d sets the display order to an initial value (i=1, step ST9), the abnormal shadows BL1, BL2, BL3 and BR1, BR2, BR3 included in the radiation images GL, GR, are marked with cursors in the order of determined combinations (step ST10). A stereo image marked with a cursor on the basis of the radiation images GL, GR marked with a cursor is displayed on the monitor 9 (step ST11). Thereby, a cursor will be displayed at a position of an abnormal shadow in the stereo image displayed on the monitor 9.

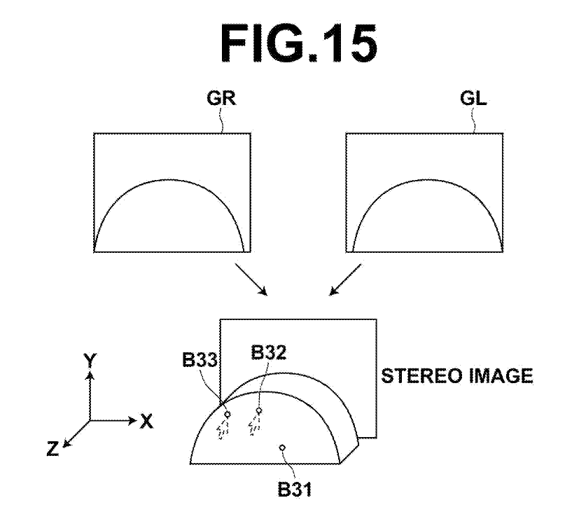

In the case that the abnormal shadow marked with a cursor in each of the two radiation images GL, GR is an abnormal shadow of the same lesion as included in the breast M, i.e., the abnormal shadows marked with cursors correspond to each other, a three dimensional cursor C1 having the same stereoscopic effect as that of the abnormal shadow B33 will be displayed at the position of the corresponding abnormal shadow (which is assumed to be B33) in the stereo image marked with cursors displayed on the monitor 9. In contrast, in the case that the abnormal shadows marked with cursors do not correspond to each other, the abnormal shadows B31 through B33 can be stereoscopically viewed in the stereo image marked with a cursor displayed on the monitor 9, but the cursor cannot be stereoscopically viewed therein, as shown in FIG. 15. This enables the observer to judge whether a combination of abnormal shadows currently marked with a cursor is appropriate by observing the stereo image displayed on the monitor 9.

For this reason, the display control section 8d judges whether a change instruction to change to a next combination is input (step ST 12). If an affirmative judgment is made in step ST12, a change of the display order is made to a next combination (i=i+1, step ST13), the process returns to step ST10 and the processes after step ST10 are repeated. If a negative judgment is made in step ST12, the display control section 8d judges whether a confirmation instruction for a current combination is input (step ST14). If a negative judgment is made in step ST14, the process returns to step ST12. If an affirmative judgment is made in step ST14, the current combination of abnormal shadows will be specified as corresponding abnormal shadows (step ST16). Note that the information of the specified combination of abnormal shadows is stored in a storage device of the computer 8. Subsequently, combinations are excluded, which cannot exist if the combinations of the currently-displayed cursors are excluded from the combinations which have not been displayed with a cursor marked up to this point in time (step ST16).

That is, in the combinations as shown in FIG. 11, in the case that the combination of the abnormal shadows BL1, BR1 is marked with a cursor and the abnormal shadows BL1, BR1 correspond to the same lesion, the combinations including the abnormal shadow BL1, BR1 should be excluded from among the combinations in the displayed order as shown in FIG. 11. In such a manner, the combinations are excluded, which cannot exist if combinations of cursors currently being displayed are excluded from the combinations that have not been displayed with a cursor marked up to that point in time. Thereby, the number of the combinations of abnormal shadows to be marked with a cursor thereafter can be considerably decreased.

Moreover, the display control section 8d judges whether a combination of abnormal shadows to be marked with a cursor has been established for each of the combinations (step ST17). If a negative judgment is made in step ST17, the process returns to step ST13 and further to step ST10. If an affirmative judgment is made in step ST17, the process is completed.

When the three-dimensional cursor is displayed and abnormal shadows are designated as a target of biopsy in this manner, the control section 8a obtains the position information (x, y, z) of the target and outputs the position information to a needle position controller 35 of the biopsy unit 2.

If a predetermined operation button is depressed at the input section 7 in this state, a control signal for moving the biopsy needle 21 is output from the control section 8a to the needle position controller 35. Based on the values of the previously input position information, the needle position controller 35 moves the biopsy needle 21 so that the tip of the biopsy needle 21 is disposed above the position indicated by the coordinates thereof.

Thereafter, when a predetermined operation for instructing puncture by the biopsy needle is performed at the input section 7, the biopsy needle 21 is moved such that the tip of the biopsy needle 21 is disposed at the position indicated by the coordinate under control of the control section 8a and needle position controller 35, and the breast is punctured by the biopsy needle 21.

In such a manner, in the present embodiment, all available combinations of the abnormal shadows corresponding to each other between the radiation images GL and GR are determined, and each of the abnormal shadows of the determined combinations is sequentially marked with a cursor. Then, based on the radiation images GL, GR marked with cursors, the stereo images marked with a cursor, in which cursors mark the abnormal shadows, are sequentially displayed.

Thereby, the operator can confirm which combinations of abnormal shadows are appropriate, i.e., which abnormal shadows correspond to each other in the radiation images GL, GR by observing the stereo images marked with cursors which are sequentially displayed. This eliminates the need for carrying out processes to search for abnormal shadows corresponding to each other in the radiation images GL, GR. Thereby, the corresponding abnormal shadows can be efficiently specified in a short time, and the stereo images in which the corresponding abnormal shadows are marked with the three-dimensional cursors can be displayed.

Further, if combinations which cannot geometrically exist are excluded from the combinations of abnormal shadows, it will no longer be necessary to display the stereo images marked with cursors by applying the cursors to the combinations of abnormal shadows, which cannot exist as the corresponding abnormal shadows. This enables the combinations of abnormal shadows corresponding to each other in the radiation images GL, GR to be determined more quickly.

Further, cursors are applied to combinations of abnormal shadows starting from a combination of abnormal shadows, which are disposed very close to each other, in the radiation images GL, GR. Thereby, combinations of corresponding abnormal shadows can be efficiently determined in an early stage when the stereo images marked with cursors are sequentially displayed.

In the case that the combinations of the abnormal shadows are determined, if combinations are excluded based on the determined combinations, the number of the remaining combinations of abnormal shadows can be reduced. Thereby, the combinations of corresponding abnormal shadows can be efficiently determined in a short time.

Further, the processes after step ST6 are carried out only in the case that abnormal shadows having the same y-coordinate exist. Therefore, in the case that corresponding abnormal shadows are easily specified, it will no longer be necessary to perform the processes after step ST6 and thereby processes for applying cursors can be carried out rapidly.

Note that in the above embodiment, either one of two radiation images may be displayed in the monitor 9, and only the combinations of abnormal shadows designated in the displayed radiation image may be sequentially marked with a cursor. The following processes will be described as an alternate embodiment of the present invention.

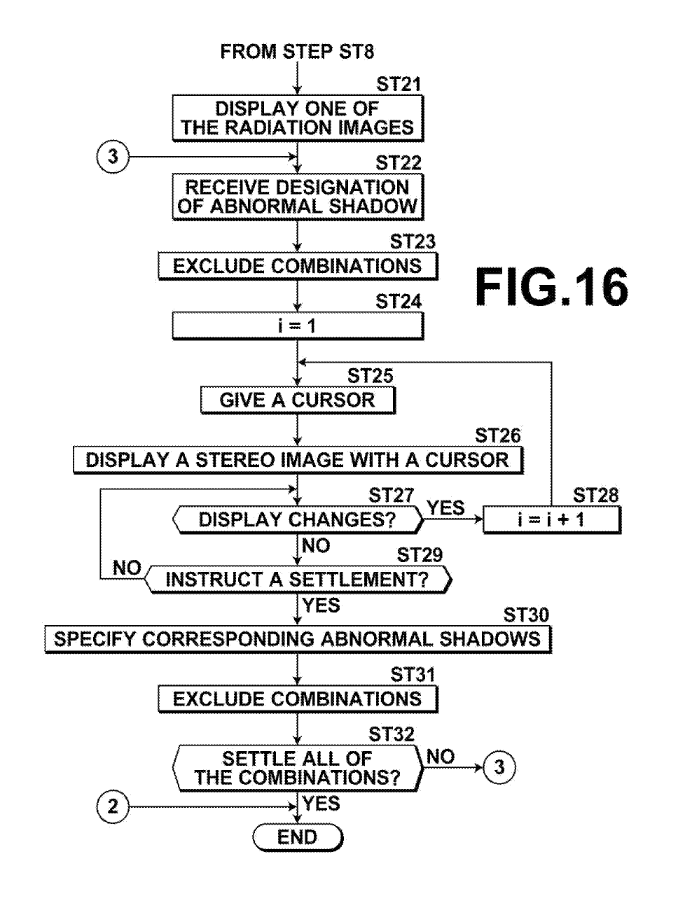

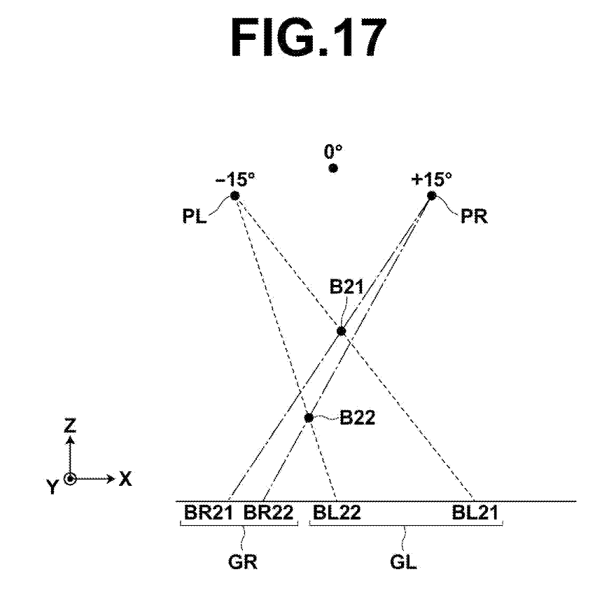

FIG. 16 is a flowchart illustrating processes carried out in the alternate embodiment. Note that in the alternate embodiment, only the processes after step ST9 are different from those illustrated in the flowcharts of FIGS. 5 and 6. Following step ST8, the display control section 8d displays one radiation image (for example, the radiation image GR) of the radiation images GL, GR on the monitor 9 (step ST21). Note that the display of this radiation image is a two-dimensional display which cannot achieve stereoscopic viewing. Then, a designation of abnormal shadows to be marked with cursors is received from an operator (step ST22), and combinations other than the combinations including the designated abnormal shadows are excluded (step ST23). Then, the display order is set to an initial value (i=1, step ST24), and the abnormal shadows included in each of the radiation images GL and GR are marked with cursors in the order of combinations after the exclusion process (step ST25). The stereo images marked with cursors based on the radiation images GL and GR marked with cursors are three-dimensionally displayed on the monitor 9 (step ST26). Thereby, the stereo images are displayed with cursors marked at positions of abnormal shadows on the monitor 9.

The display control section 8d judges whether a change instruction for the next combination is input (step ST27). If an affirmative judgment is made in step ST27, the display order is changed to the next combination (i=i+1, step ST28) and the process returns to step ST25 to repeat the processes after step ST25. Thereby, in the case that the operator designates the abnormal shadow BR2, the abnormal shadows of the combinations (BR2, BL1), (BR2, BL2) and (BR2, BL3) are marked with cursors in this order, and the stereo images marked with cursors are sequentially displayed. If a negative judgment is made in step ST27, the display control section 8d judges whether a confirmation instruction for the current combination is input (step ST29). If a negative judgment is made in step ST29, the process returns to step ST27. If an affirmative judgment is made in step ST29, the abnormal shadows of the current combination is specified as corresponding abnormal shadows (step ST30). In this case, the information of the specified combination of abnormal shadows is stored in the storage device of the computer 8. Subsequently, combinations, which cannot exist if the combinations of the currently displayed cursors are excluded from the combinations of abnormal shadows which have not been displayed with cursors marked up to this point in time, are excluded (step ST31).

Further, the display control section 8d judges whether the combinations of abnormal shadows to be marked with cursors for all of the combinations are confirmed (step ST32). If a negative judgment is made in step ST32, the process returns to step ST22 to receive an instruction for designating the next abnormal shadow. If an affirmative judgment is made in step ST32, the process is completed.

Although the above embodiments were described as cases in which an embodiment of the radiation image displaying system of the present invention is applied to a stereo breast image capturing and displaying system, the subject of the radiation image displaying system of the present invention is not limited to breasts and the present invention may also be applied to radiation image capturing and displaying systems that capture chest regions or head regions.

What is claimed is:

1. A radiation image displaying apparatus, comprising:
an abnormal shadow detection section that detects an abnormal shadow from each of two radiation images for displaying a stereoscopic image, obtained by imaging a subject from two different directions;
a display section that displays the stereoscopic image; and
a display control section that determines all available combinations of abnormal shadows as abnormal shadows corresponding to each other between the two radiation images in the case that a plurality of abnormal shadows are detected and sequentially applies cursors to abnormal shadows of the determined combinations in two radiation images, and sequentially display the stereoscopic images marked with the cursors, in which the abnormal shadows are marked with the cursors, on the display means based on the two radiation images marked with the cursors.

2. The radiation image displaying apparatus as claimed in claim 1, further comprising:
an input section that receives input of instructions for determining combinations of abnormal shadows to be marked with cursors; and
wherein the display control section specifies the abnormal shadows of the determined combinations as corresponding abnormal shadows.

3. The radiation image displaying apparatus as claimed in claim 1, wherein the display control section excludes combinations which cannot geometrically exist from the combinations of abnormal shadows, and sequentially displays the stereoscopic images marked with cursors.

4. The radiation image displaying apparatus as claimed in claim 1, wherein the display control section sequentially applies cursors to combinations of abnormal shadows starting from a combination of abnormal shadows which are close to each other, and sequentially displays a stereoscopic image marked with a cursor.

5. The radiation image displaying apparatus as claimed in claim 1, wherein the display control section excludes combinations based on the determined combinations and sequentially displays the stereoscopic images marked with cursors, in the case that combinations of abnormal shadows are determined.

6. The radiation displaying apparatus as claimed in claim 1, wherein the display control section judges whether a plurality of abnormal shadows are arranged in a direction corresponding to two directions of the two radiation images and determines combinations of the abnormal shadows to display the stereoscopic images marked with cursors only in the case that an affirmative judgment is made.

7. The radiation displaying apparatus as claimed in claim 1, wherein the display control section displays either one of the two radiation images on the display means and sequentially applies cursors only to combinations of abnormal shadows designated in the displayed radiation image, and sequentially displays the stereoscopic images marked with the cursors.

8. A radiation image displaying method which is employed in the radiation image displaying apparatus including an abnormal shadow detection section that detects abnormal shadows from each of two radiation images for displaying a stereoscopic image, obtained by imaging a subject from two different directions and a display section that displays a stereoscopic image, the radiation image displaying method comprising:
determining all available combinations of abnormal shadows as abnormal shadows corresponding to each other between the two radiation images in the case that a plurality of abnormal shadows are detected;
sequentially applying cursors to abnormal shadows of the determined combinations in the two radiation images; and
sequentially displaying stereoscopic images marked with the cursors, in which the abnormal shadows are marked with the cursors, on the display means, based on the two radiation images marked with the cursors.
